(19) United States
(12) Patent Application Publication
(10) Pub. No.: US 2024/0001386 A1
(43) Pub. Date: Jan. 4, 2024

(54) DISPENSING DEVICE AND DISPENSER

(71) Applicant: APTAR DORTMUND GMBH, Dortmund (DE)

(72) Inventors: Guido BURMANN, Dortmund (DE); Börje HEGENBERG, Dortmund (DE)

(21) Appl. No.: 18/039,456

(22) PCT Filed: Dec. 6, 2021
(86) PCT No.: PCT/EP2021/084379

§ 371 Date: May 30, 2023

(30) Foreign Application Priority Data
Dec. 4, 2020 (DE) 10 2020 007 396.4

(51) Int. Cl. B05B 11/10; B05B 1/12; B05B 11/00; B05B 1/16

(52) U.S. Cl. CPC B05B 11/1035; B05B 1/12; B05B 11/0008; B05B 11/103; B05B 11/1059; B05B 11/1095; B05B 1/1654; B05B 11/1033

(57) ABSTRACT

A dispensing device for dispensing a fluid is proposed. The dispensing device comprises an outer housing and a conveying device for conveying the fluid from a container. At a channel opening of an outlet channel, the dispensing device may have a rotatable dispensing element, wherein by rotation different dispensing forms of the fluid, in particular as a spray or as a foam, can be set and/or the channel opening can be closed. In particular, the dispensing element may comprise a passage opening with an injection-molded grid made of plastic. Furthermore, the outer housing preferably has a multi-part structure with a dividing plane extending transversely to a central axis of the conveying device. Preferably, the conveying device comprises a conveyor housing which is completely accommodated in the outer housing and/or is formed integrally or as a structural unit with the outlet channel. Furthermore, a dispenser for dispensing a fluid comprising a container and a dispensing device is proposed.

### CROSS-REFERENCE TO RELATED APPLICATIONS

The present application is a national stage application under 35 U.S.C. 371 of PCT Application No. PCT/EP2021/084379, filed 6 Dec. 2021, which designated the United States, which PCT application claimed the benefit of German Patent Application No. 10 2020 007 396.4, filed 4 Dec. 2020, each of which are incorporated herein by reference in their entirety.

### BACKGROUND

The present invention relates to a dispensing device for dispensing a fluid, a dispenser for dispensing a fluid, and a method of manufacturing a dispensing device.

In particular, the present invention relates to a dispenser for the storage and the discharge and/or dispensing of cleaning agents or pharmaceutical or cosmetic fluids, in particular liquids. A fluid can be accommodated in a container of the dispenser, which fluid can be conveyed out of the container by means of a dispensing device attached to the container and can be dispensed by means of the dispensing device. The fluid may be dispensed in various dispensing forms or types, for example as a spray or aerosol and/or as a foam.

WO 2019/175349 A1 relates to a dispensing device for dispensing a fluid, comprising a pumping device for conveying the fluid from a container. The pumping device comprises a bellows for pumping and can be actuated by means of a manually operable actuating lever. The actuating lever is securable against undesired actuation. In a first embodiment, an actuating arm of the actuating lever is folded up in a secured position, and is in particular secured to a dispensing head of the dispensing device. In a second embodiment, the actuating lever comprises a blocking element which is pivotable relative to the actuating arm and which can be arranged between the actuating arm and a housing of the dispensing device, thereby blocking pivoting of the actuating lever.

EP 2 767 348 A1 relates to a perforated plate for a liquid dispenser and a method for its manufacture. The perforated plate has a plurality of micro-openings and is made of plastic by injection molding.

US 2013/0119157 A1 relates to a trigger-operated dispensing device for a liquid comprising a nozzle and an insert applied to the nozzle. The insert is rotatable around the dispensing axis and is provided with two openings for dispensing the liquid as a spray or as a foam. For example, the insert may comprise a mesh applied to the second opening to dispense the liquid as a foam.

WO 2012/064790 A1 relates to a liquid spraying device offering both a spraying and a foaming configuration. The device comprises an inner nozzle and an outer nozzle arranged behind each other in the direction of flow. The side of the outer nozzle facing the inner nozzle is provided with a screen which may be a woven mesh screen welded to the outer nozzle or may be an integrated molded screen. By turning the outer nozzle, a user can move the outer nozzle forward of the inner nozzle, and thus switch between configurations. In a foaming configuration, the outer nozzle is displaced by a given distance from the inner nozzle such that the spray leaving the inner nozzle will fall upon the screen, thus creating foam. In a spraying configuration, the screen lies flush against the inner nozzle such that the liquid stream leaving the inner nozzle goes through a hole in the center of the screen and thus no foam is created.

EP2 345 480 A1 relates to a trigger-operated dispenser device able to dispense liquid according to at least two types of jet dispensed. The device comprises a nozzle positioned downline of a duct, wherein the nozzle is rotatable around a dispensing axis to bring one of two different openings in fluid connection with the duct so as to select the type of jet desired. The device may further comprise an insert externally attached to the nozzle for changing the jet exiting one of the openings to a foam. For this purpose, the insert may comprise a net positioned on an insert window in fluid communication with the respective nozzle opening.

DE 27 44 654 A1 relates to a device for atomizing a liquid with a piston arrangement which is actuable by actuating a pump lever. The device comprises a housing having a lower part and an upper part attached to the lower part. The lower part is screwed onto a container and comprises a pump chamber. The device further comprises a nozzle cap screwed onto a nozzle head. A spray pattern of the device can be set by rotating the nozzle cap.

US 2018/0193857 A1 relates to a fluid dispensing system comprising a stiff outer container and a flexible inner container or bag with the fluid. A dispensing device is connected to the container, wherein the dispensing device comprises a housing or frame of which a part is integrally formed with one of the containers. The part of the dispensing device that is not integrally formed with one of the containers comprises a trigger, piston arrangement and outflow channel and is mechanically fastened to the integrated part.

### SUMMARY

It is an object of the present invention to enable a simple, reliable and/or safe functioning and/or handling and/or a simple construction of a dispensing device and/or dispenser and/or to provide a dispensing device that is versatile and/or universally applicable and/or customizable.

The above object is solved by a dispensing device, by a dispenser or by a method as disclosed herein.

A proposed dispensing device is designed to dispense a fluid, in particular a fluid received in an associated container and/or in a container connected to the dispensing device.

For discharging or dispensing the fluid, the dispensing device has an outlet channel with a channel opening. Via the outlet channel or via the channel opening, fluid can preferably be discharged or dispensed from the dispensing device. The channel opening may be formed as a nozzle or comprise a nozzle.

The dispensing device comprises a conveying device for conveying the fluid. The conveying device is preferably a pumping device or designed as a pump or has such a pumping device. Particularly preferably, the conveying device or pumping device comprises a flexible bellows for conveying the fluid. In particular, the fluid can be conveyed into the bellows by an expansion of the bellows and/or a negative pressure resulting from the expansion and can be dispensed from the bellows by a compression of the bellows. However, other solutions are also possible here. For example, instead of a bellows, the pumping device may comprise a pump piston or the like as a conveying element. Furthermore, the conveying device may also be implemented without a pump or pumping device, for example in the case of a pressurized container.

According to the proposal, the dispensing device or the dispenser provided with the dispensing device comprises an outer housing in which the conveying device is received/accommodated and/or held. Preferably, the outlet channel is, at least partially, in particular completely, received/accommodated in or formed by the outer housing.

According to a first aspect of the present invention, the dispensing device or the dispenser provided with the dispensing device comprises a dispensing element arranged at or behind the outlet channel and/or channel opening (in the direction of fluid discharge and/or the direction of fluid conveyance in the outlet channel). The dispensing element is movably, in particular rotatably, mounted or arranged on the dispensing device, the outer housing, the outlet channel and/or the channel opening.

The dispensing element preferably has a passage opening by means of which the dispensing form or dispensing type of the fluid is or can be changed, for example to a spray or foam. In particular, the dispensing device can be of substantially the same construction for different purposes of use, and differ only by the dispensing element or its passage opening. This allows for a dispensing device that is easy to adapt or customize.

Preferably, the passage opening is formed as a grid or comprises a grid. Particularly preferably, the dispensing form of the fluid is changed by means of the grid, especially preferably to a foam.

Preferably, the grid is made of plastic and/or injection molded. In particular, the grid may be manufactured according to the method described in EP 2 767 348 A1, the contents of which are hereby incorporated into this application. This enables a particularly simply and/or inexpensively manufactured dispensing element.

Particularly preferably, the dispensing element, in particular including the grid, is manufactured in one piece and/or injection molded. This is conducive to a simple construction.

Preferably, by rotating the dispensing element, the grid can be moved away from the channel opening. This preferably allows the channel opening to be closed by means of the dispensing element and/or a further or different passage opening of the dispensing element to be arranged behind the channel opening and/or the channel opening to be exposed and/or the dispensing device to be used without the grid. This is conducive to a versatile or universally usable dispensing device.

The dispensing element may have only one passage opening, which is in particular in the form of a grid.

Preferably, the dispensing element has multiple, in particular two, passage openings. By rotating the dispensing element with multiple, in particular (exactly) two, passage openings, different dispensing forms of the fluid can be set or selected. In particular, the same dispensing device can be used for different purposes. In this way, a versatile and/or universally usable dispensing device is made possible.

Preferably, the fluid is dispensable either as a spray or as a foam by rotating the dispensing element. In this way, a versatile and/or universally applicable dispensing device is made possible.

Particularly preferably, the dispensing element can assume (at least) two positions, wherein in a first position a first passage opening, in particular for dispensing the fluid as a spray, is arranged at or behind the channel opening, and in a second position a second passage opening, in particular with a grid, in particular for dispensing the fluid as a foam, is arranged at or behind the channel opening. Preferably, the dispensing element can close the channel opening in a third position.

According to a further aspect of the present invention, which can also be implemented independently, the outer housing is formed in multiple parts, in particular in two parts, and/or comprises multiple, in particular (exactly) two, housing parts. In this case, the dividing plane of the outer housing runs transversely to a central axis or longitudinal axis of the conveying device and/or transversely to a (main) conveying direction of the fluid in the dispenser, the dispensing device, the conveying device and/or the bellows and/or transversely to the vertical in the usual position of use, and/or at least substantially parallel to a longitudinal extension of the outlet channel and/or to a conveying direction of the fluid in the outlet channel and/or at least substantially horizontally in the usual position of use. Particularly preferably, the dividing plane runs asymmetrically through the outer housing and/or does not form a plane of symmetry of the outer housing. In particular, the housing parts are formed differently or not mirror-inverted to each other. This enables a particularly simple construction of the dispensing device and/or a customizable dispensing device.

Preferably, the conveying device and/or the outlet channel is held or supported between the housing parts of the outer housing. This is conducive to a simple and/or safe construction.

Preferably the housing parts are or can be plugged together, more preferably are or can be latched, snapped or clicked together. This is conducive to a simple and/or safe assembly.

According to a further aspect of the present invention, which can also be implemented independently, the conveying device comprises a conveyor housing. Preferably, the conveyor housing forms a structural unit with the outlet channel and/or is formed or manufactured integrally or in one piece with the outlet channel, in particular injection-molded, and/or is completely accommodated in the outer housing, in particular together with the outlet channel. This is conducive to a particularly simple and/or safe structure.

Preferably, the outlet channel is arranged or formed eccentrically or off-center in the outer housing and/or on the conveyor housing, in particular eccentrically or off-center with respect to a (vertical) symmetry plane of the outer housing and/or the conveyor housing. Preferably, the channel opening and/or the passage opening is arranged eccentrically or off-center on the dispensing device and/or on the outer housing.

The pumping device, in particular the bellows, is preferably completely arranged within and/or held by the conveyor housing. Particularly preferably, the pumping device, in particular the bellows, is held at its top or upper end by the conveyor housing, in particular at a top or upper end of the conveyor housing.

Particularly preferably, the pumping device, in particular the bellows, is arranged within the conveyor housing, in particular completely, and the conveyor housing is accommodated within the outer housing, in particular completely.

The conveyor housing has preferably at least essentially the shape of a (hollow) cylinder, preferably (at least essentially) closed at the top. In particular, the conveyor housing comprises an at least cylindrical lateral wall and and/or a disc-like top wall. The conveyor housing is preferably open at its lower end or bottom.

Preferably, the top wall of the conveyor housing comprises an aperture which opens into the outlet channel.

The pumping device, in particular the bellows, preferably forms a pump chamber for the fluid, particularly preferably together with a top or upper end of the conveyor housing. The pump chamber is preferably delimited laterally and/or at its lower end or bottom by the pumping device or bellows, and at its upper end or top by the conveyor housing. In particular, the lateral wall of the conveyor housing is spaced apart from the pump chamber.

The outer housing and/or the conveyor housing preferably comprise(s) (each) a clearance, in particular laterally or at the lateral wall, through which an actuating lever for actuating the dispensing device, in particular the pumping device, is or can be passed.

The above-described shape and/or structure of the conveying device, in particular the conveyor housing, is preferably conducive to a particularly simple and/or safe structure and or a particularly easy and/or inexpensive manufacture.

According to another aspect of the present invention, which may also be implemented independently, the conveyor housing holds the outer housing axially and/or attaches or fixes the outer housing to a connection part, the connection part being configured to connect the dispensing device to the container. In particular, the outer housing comprises a connecting portion clamped or fixed between the conveyor housing and the connection part. This allows for a particularly simple and/or stable and/or safe structure.

Preferably, the connection part comprises one or more latching or interlocking or clamping elements. The conveying device, in particular the conveyor housing, and the outer housing, in particular the lower housing part, preferably comprise (each) one or more corresponding, for example flange-like, connecting portions for interlocking or latching with the latching/interlocking/clamping elements of the connection part.

Particularly preferably, the latching/interlocking/clamping element(s) of the connection part engage(s) over both the one or more connecting portions of the conveying device and the one or more connecting portions of the outer housing, thereby clamping the connection part, conveying device, and outer housing together. This is conducive for a particularly simple and/or stable and/or safe structure and/or easy and/or inexpensive manufacture.

Another aspect of the present invention, which may also be implemented independently, relates to a method of manufacturing a dispensing device. In the method, a conveyor housing of the conveying device is interlocked or latched with a connection part associated with the container. A connecting portion of the outer housing, in particular of a lower housing part of the outer housing, is thereby fixed between the conveyor housing and the connection part. In particular, the outer housing or its lower housing part is hereby fixed to the connection part. This is conducive to a particularly simple and/or stable and/or safe structure.

Preferably, the conveying device is arranged in the lower housing part and the outer housing is closed with an upper housing part. Particularly preferably, the upper housing part is plugged onto and/or latched to and/or interlocked with the lower housing part. This is conducive to a particularly simple, stable and/or safe structure.

According to a further aspect of the present invention, which may also be implemented independently, the outer housing, the conveying device and the connection part are connected to each other exclusively by plugging, latching, clamping, interlocking, snapping and/or clicking together, and/or are connected to each other exclusively by plugging, latching, clamping, interlocking, snapping and/or clicking together in a corresponding manufacturing method. This is conducive to a particularly simple, stable and/or safe structure.

The proposed dispenser for dispensing a fluid is provided with the proposed dispensing device and a container. The fluid is conveyable from the container by means of the dispensing device and dispensable from the dispenser by means of the dispensing device. Thus, the corresponding advantages are obtained.

Particularly preferably, the dispenser and/or the dispensing device is recyclable and/or (exclusively) made of recyclable material and/or recyclable plastic. In particular, the container, the outer housing, the conveying device, the bellows, the conveyor housing, the outlet channel, the dispensing element, an actuating lever for actuating the conveying device and/or further components, particularly preferably all components of the dispensing device and/or of the dispenser, are made or formed from recyclable material and/or recyclable plastic and/or plastic from the polyethylene family. This is conducive to a simple, sustainable and/or environmentally friendly construction.

The foregoing and subsequent aspects and features of the present invention may be combined with each other as desired, but each may also be implemented independently.

Further aspects, features, advantages and characteristics of the present invention will be apparent from the claims and the following description of a preferred embodiment with reference to the drawings.

### BRIEF DESCRIPTION OF THE DRAWINGS

FIG. 1A is a schematic side view of a proposed dispenser with a proposed dispensing device;

FIG. 1B is a sectional view of the dispenser according to FIG. 1;

FIG. 2A is a magnified sectional view of the dispensing device in a locked state;

FIG. 2B is a sectional view of the dispensing device in an unlocked state;

FIG. 2C is a sectional view of the dispensing device with actuated conveying device;

FIG. 3 is a perspective exploded view of the dispensing device;

FIG. 4 is a perspective view of an outer housing of the dispensing device;

FIG. 5 is a front view of the outer housing; and

FIG. 6 is a section through the outer housing.

### DETAILED DESCRIPTION

In the figures, the same reference signs are used for the same or similar components and devices, wherein the same or corresponding advantages and features may result, even if a repeated description is omitted.

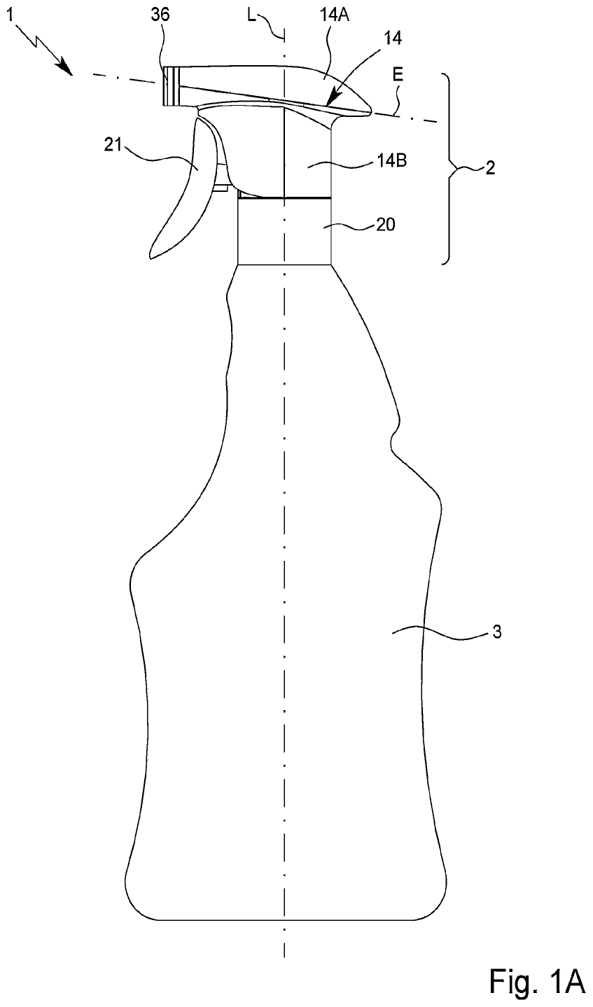

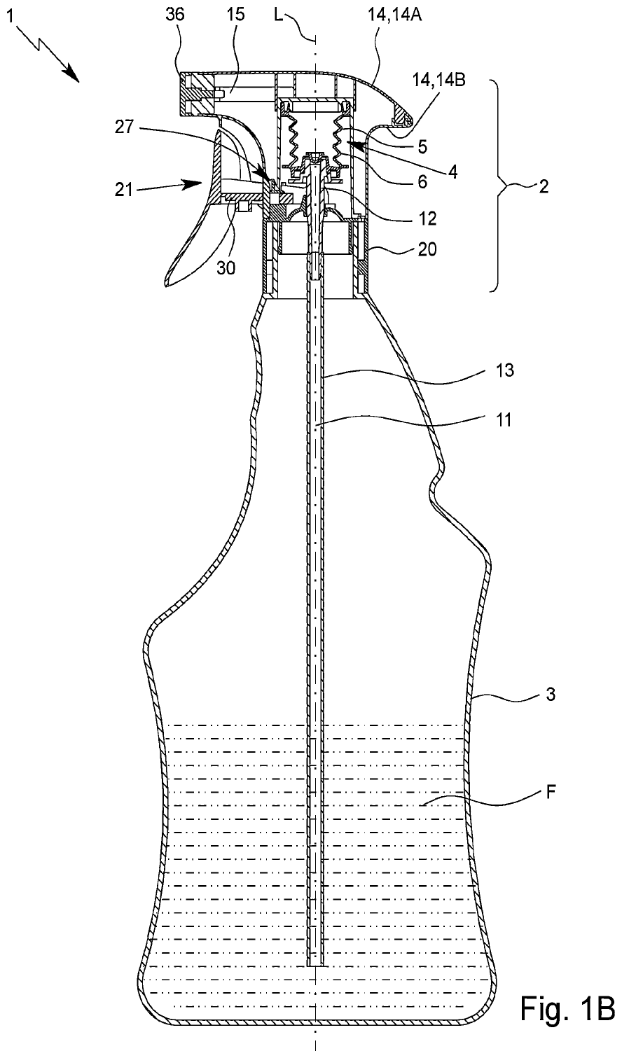

FIG. 1A shows a proposed dispenser 1 with a proposed dispensing device 2 and a container 3 in a schematic side view. FIG. 1B shows the proposed dispenser 1 in a schematic sectional view.

A fluid F can be received/accommodated in the dispenser 1 or container 3. The dispensing device 2 is designed or provided for conveying the fluid F from the container 3 and for discharging or dispensing the fluid F.

The fluid F is preferably a (low viscosity) liquid, in particular a cleaning liquid or the like, but may also have a viscous to pasty consistency and/or a high viscosity.

The fluid F is dispensed by the dispensing device 2 preferably or optionally as a spray or aerosol and/or as a foam. However, other solutions are also possible here.

The dispenser 1 is preferably marketed and/or sold to an end customer as a disposable article and filled with the fluid F. The dispenser 1 is particularly suitable for cleaning liquids, such as glass cleaner or the like, but can also be used for any other fluids F.

Preferably, the dispenser 1 and/or the dispensing device 2 have/has a (common) central axis or longitudinal axis L.

The axis L is preferably oriented at least substantially plumb/upright (vertical) in a usual storage position and/or use position of the dispenser 1, as also shown in the figures. In particular, in use, the dispensing device 2 or an outer housing 14 of the dispensing device 2 is typically at the top and the container 3 is at the bottom. In particular, at least in the storage position, the axis L is at least substantially parallel to gravity. In the storage position, the dispenser 1 preferably rests on a bottom/base of the container 3.

In the present invention, the term “axial” direction or movement preferably refers to a direction or movement that is along or parallel to the axis L. In an analogous manner, the term “radial” preferably also refers to the axis L.

In the present invention, the terms “top” and “bottom” and variations thereof and terms similar thereto preferably have the usual common language meaning with respect to the preferred orientation or position of use, and in the present invention preferably refer to the storage position of the dispenser 1 or dispensing device 2 as shown in the figures.

The dispensing device 2 preferably comprises an actuating lever 21 which is in particular pivotable. A dispensing of the fluid F from the dispenser 1 and/or the dispensing device 2 is preferably performed by manual actuation and/or pivoting of the actuating lever 21.

Preferably, the dispensing device 2 comprises a conveying device 4 for conveying the fluid F, in particular from or out of the container 3. The conveying device 4 is preferably actuatable by means of the actuating lever 21.

In the preferred embodiment shown, the conveying device 4 is preferably designed as a pumping device and/or comprises a pumping device or pump. In particular, the conveying device 4 is designed to convey or pump the fluid F from the container 3 into the dispensing device 2 and/or to dispense the fluid F from the dispensing device 2 and/or via a closure element or dispensing element 36. By manually actuating and/or pivoting the actuating lever 21, the fluid F is preferably pumped out of the container 3 and/or dispensed from the dispensing device 2 and/or via the closure element or dispensing element 36.

Preferably, the dispensing device 2 and/or the actuating lever 21 is lockable or locked in a locking state and/or a locking position, in particular in the delivery state. In the locking position, an actuation of the conveying device 4 and/or a dispensing of the fluid F is preferably locked or blocked/inhibited.

The delivery state is preferably the state in which the dispenser 1 or dispensing device 2 is delivered or shipped, in particular from the factory, and/or in which the dispenser 1 or dispensing device 2 is sold. In particular, the delivery state is the state before first use of the dispenser 1 or dispensing device 2.

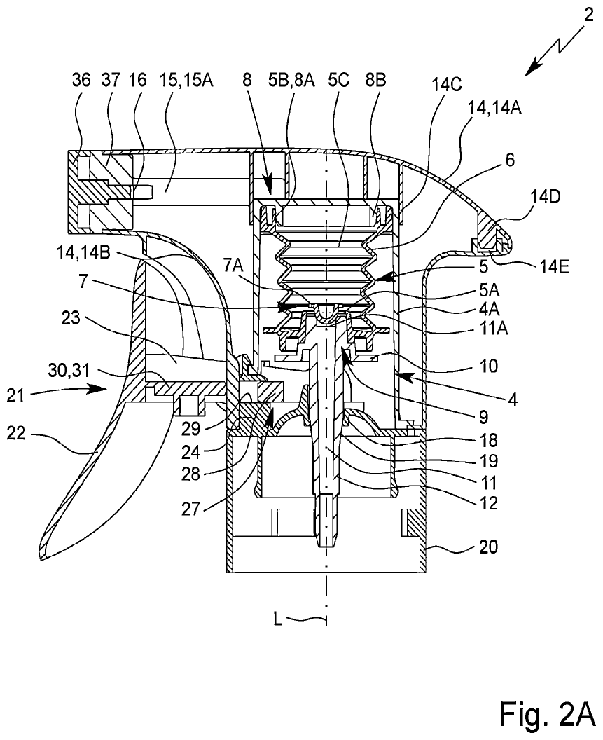

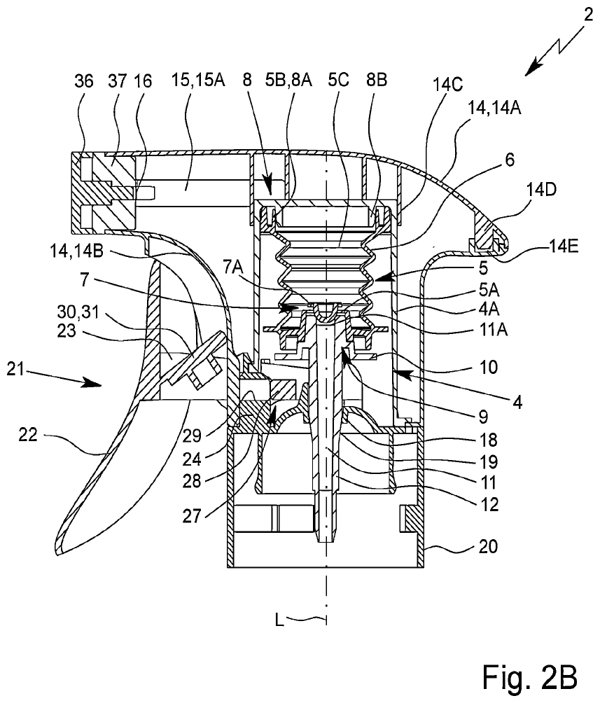

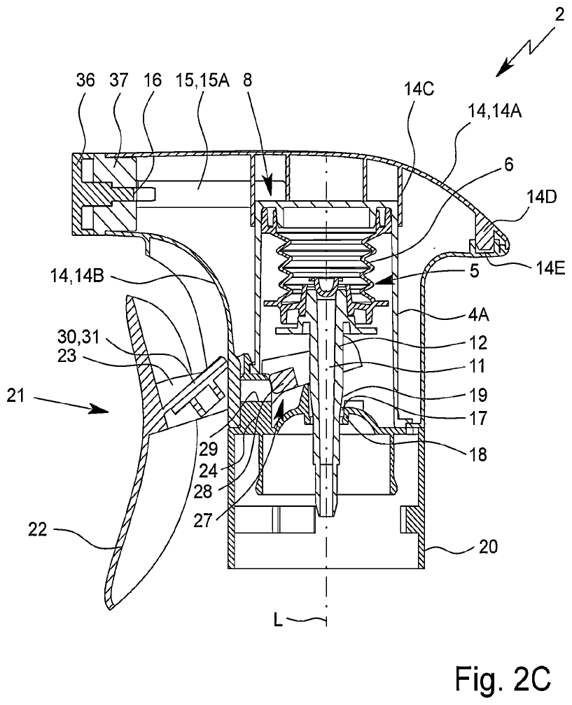

FIG. 2 shows the dispensing device 2 in a section corresponding to FIG. 1B in an enlarged view. FIG. 2A shows the dispensing device 2 in the locked state, FIG. 2B in the unlocked, unactuated state and FIG. 2C in the actuated state or with actuated conveying device 4.

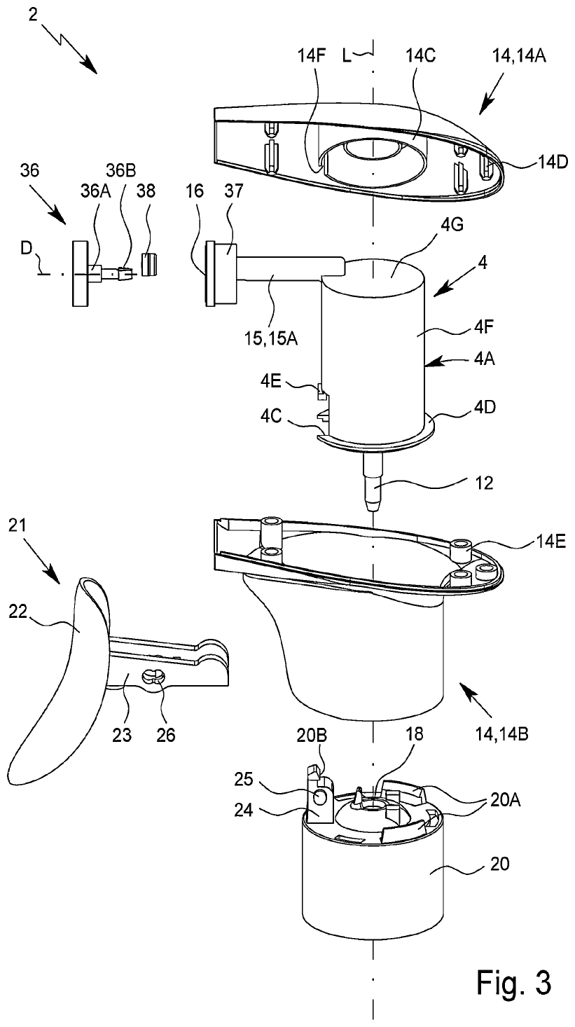

FIG. 3 is an exploded view of the dispensing device 2, showing in particular the different structural units of the dispensing device 2.

The design/construction of the conveying device 4 as a pumping device described in the following is preferred, but not essential. The following description is therefore merely exemplary.

In the illustrated preferred embodiment of the conveying device 4, the latter comprises a bellows 5 or a pumping device is formed by the bellows 5. However, instead of the bellows 5, other solutions for a pumping device are also possible. For example, instead of the bellows 5, a cylinder-piston arrangement is also conceivable, for example similar to the cylinder-piston arrangement described in U.S. Pat. No. 3,840,157.

The dispensing device 2 and/or conveying device 4 preferably comprises a conveyor housing 4A. The conveyor housing 4A is preferably at least substantially sleeve-like or ring-like or hollow-cylindrical and/or arranged coaxially to the axis L.

The conveyor housing 4A is preferably stiff or rigid.

Preferably, the conveyor housing 4A is closed at the top and/or open at the bottom.

The conveyor housing 4A preferably comprises a lateral wall 4F and/or a top wall 4G. The lateral wall 4F is preferably at least essentially cylindrical and/or the top wall 4G is preferably at least essentially disc-shaped. Particularly preferably, the lateral wall 4F and top wall 4G are integrally formed.

The conveyor housing 4A and/or the lateral wall 4F and/or the top wall 4G are preferably arranged coaxially to the axis L and/or the symmetry axis of the conveyor housing 4A, lateral wall 4F and/or top wall 4G coincide with the axis L or define the axis L.

Preferably, the pumping device and/or the bellows 5 are at least partially arranged within the conveyor housing 4A or accommodated within the conveyor housing 4A. Preferably, the bellows 5 is arranged (completely) within the conveyor housing 4A and/or coaxially thereto.

Particularly preferably, the pumping device or bellows 5 is held, in particular at its upper end by the conveyor housing 4A, preferably at the top wall 4G.

Preferably, the bellows 5 is flexible and/or elastically deformable and/or the bellows 5 consists of a flexible and/or elastically deformable material. Particularly preferably, the bellows 5 consists of a recyclable material and/or a recyclable plastic and/or a plastic from the polyethylene family.

The bellows 5 is preferably designed/configured to return, after a deformation, to an initial position or unactuated position or rest position assumed before the deformation.

The bellows 5 is preferably installed or arranged in the dispenser 1 and/or the dispensing device 2 and/or the conveying device 4 and/or the conveyor housing 4A in a pretensioned and/or (slightly) compressed manner. This supports in particular a reliable conveying of the fluid F.

The bellows 5 is preferably at least substantially cylindrical or hollow cylindrical. A lateral surface or side wall 6 of the bellows 5 is preferably wavy or corrugated. Preferably, this increases the flexibility and/or elastic restoring force that drives or moves the bellows 5 back to the initial position or rest position. Furthermore, the wavy design preferably avoids damage in case of deformation of the bellows 5 and/or increases the stability of the bellows 5.

The bellows 5 and/or the side wall 6 preferably runs coaxially with the central or longitudinal axis L of the dispenser 1 and/or the dispensing device 2.

The conveying device 4 and/or the bellows 5 preferably comprises an inlet 5A for the fluid F, an outlet 5B for the fluid F and a pumping chamber or interior chamber 5C for receiving the fluid F. The interior chamber 5C is preferably formed between the inlet 5A and the outlet 5B and/or is laterally and/or radially delimited by the side wall 6.

Preferably, the interior chamber 5C is axially and/or at the top delimited by the conveyor housing 4A, in particular the top wall 4G, at least partially.

The lateral wall 4F is preferably spaced apart from the bellows 5, in particular the side wall 6. In particular, the lateral wall 4F does not form the pumping chamber or interior chamber 5C.

Preferably, the conveying device 4 and/or the bellows 5 comprises an inlet valve 7 at the inlet 5A and an outlet valve 8 at the outlet 5B. Preferably, the inlet valve 7 and the outlet valve 8 are each formed as a one-way valve. The inlet valve 7 enables or controls a supply of the fluid F to the conveying device 4 and/or the bellows 5. The outlet valve 8 enables or controls a discharge of the fluid F from the outlet 5B of the conveying device 4 and/or the bellows 5.

The inlet valve 7 and the outlet valve 8 preferably open and/or close pressure-controlled and/or automatically, in particular by a pressure difference present at the respective valve 7, 8. A preferred concrete design/construction of the valves 7, 8 will be discussed in more detail later.

The conveying device 4 and/or the bellows 5 preferably comprises a base 9. The base 9 is preferably formed as a component which is separate and/or separately manufactured from the bellows 5.

The base 9 is preferably axially movable and/or arranged within the conveyor housing 4A and/or protrudes out of the conveyor housing 4A, in particular at the bottom or towards the container 3.

The base 9 is connected, in particular on the inlet side, to the bellows 5. The bellows 5 can be connected to the base 9 in a force-fitting or friction-fitting and/or material-fitting manner or can be fastened to the base 9, in particular latched, snapped, bonded, welded and/or injection-molded.

The base 9 preferably comprises a bottom element 10. The bottom element 10 is preferably plate-like and/or preferably forms a (bottom) closing surface and/or a (bottom and/or end) closure of the conveying device 4 and/or of the bellows 5 and/or of the interior chamber 5C. The bottom element 10 is preferably at least substantially circular disc-like and/or forms an annular surface.

Preferably, the base 9 comprises or forms a feed channel or supply channel 11 for the fluid F, in particular extending axially or parallel to or along the axis L. Preferably, the supply channel 11 opens into the inlet 5A of the bellows 5.

The supply channel 11 is preferably formed and/or delimited by a conduit 12 of the base 9.

The conduit 12 and the bottom element 10 are preferably formed as a single piece.

The base 9 with the bottom element 10 and the conduit 12 may, for example, be designed and/or manufactured as an injection molded component and/or made of plastic.

Preferably, the bottom element 10 is spaced from the upper axial end of the conduit 12 or the end of the conduit 12 facing the bellows 5 and/or is spaced from the lower axial end of the conduit 12 or the end of the conduit 12 facing the container 3.

Particularly preferably, the conduit 12 forms a connection and/or protrudes downwardly and/or into the container 3.

The dispenser 1 and/or the dispensing device 2 and/or the conveying device 4 preferably comprises a riser 13 for the fluid F, as shown in particular in FIG. 1B. The riser 13 is preferably connected to the bellows 5 and/or the base 9, in particular to the supply channel 11 and/or the conduit 12, and/or arranged at a lower end and/or at an end of the base 9 and/or conduit 12 facing away from the bottom element 10 and/or the bellows 5. The riser 13 may be plugged into the conduit 12, or plugged onto the conduit 12, or otherwise connected to the conduit 12.

Preferably, the riser 13 forms an extension of the conduit 12 and/or the supply channel 11. Preferably, the conduit 12 and the riser 13 together form and/or delimit the supply channel 11.

Preferably, the central axis or longitudinal axis L forms an axis of symmetry of the conveying device 4, the conveyor housing 4A, the bellows 5, the base 9, the supply channel 11, the conduit 12 and/or the riser 13, and/or runs (centrally) through the conveying device 4, the conveyor housing 4A, the bellows 5, the base 9, the supply channel 11, the conduit 12 and/or the riser 13.

Preferably, the dispenser 1 and/or dispensing device 2 comprises an outer casing or outer housing 14, as shown in particular in FIG. 3.

Preferably, the outer housing 14 forms an (overall) outer housing of the dispensing device 2 or part of an (overall) outer housing.

Preferably, the conveying device 4 is arranged or held in the outer housing 14. Particularly preferably, the outer housing 14 is configured to receive the conveying device 4 and/or the bellows 5, in particular completely.

The conveyor housing 4A thus forms preferably an intermediate or inner housing, in particular for the bellows 5, which itself is accommodated in the outer housing 14.

Preferably, the conveying device 4 or conveyor housing 4A, in particular the lateral wall 4F, is spaced apart from the outer housing 14, in particular laterally.

In the illustrative example, the outer housing 14 is formed in two parts and/or has an upper housing part 14A and a lower housing part 14B. However, other solutions are also possible here.

The outer housing 14, in particular the upper housing part 14A, preferably comprises a mounting part or fastening part 14C for connecting or fastening the conveying device 4 and/or the bellows 5 to the outer housing 14.

The fastening part 14C is preferably ring-like or ring-shaped. Particularly preferably, the conveying device 4 is clamped in the fastening part 14C, preferably circumferentially and/or at the lateral wall 4F, in particular close to the top wall 4G. However, other solutions are also possible here.

The housing parts 14A, 14B are preferably connected or connectable to each other in a force-fit, form-fit and/or bonded manner.

Preferably, the housing parts 14A, 14B are pluggable or plugged together. Preferably, the upper housing part 14A comprises pins 14D and the lower housing part 14B comprises receptacles 14E, or vice versa, wherein the pins 14D are pluggable or plugged into the receptacles 14E, in particular in a force-fit, form-fit and/or bonded manner.

Preferably, the pins 14D are integrally formed with the upper housing part 14A and/or the receptacles 14E are integrally formed with the lower housing part 14B.

Preferably, the diameter of the pins 14D is slightly larger than the diameter of the receptacles 14E, so that a force-fit connection is realized by press fit or interference fit.

The receptacles 14E are preferably formed as in particular hollow cylindrical portions, preferably protruding in the axial direction or parallel to the axis L or upwards in the normal position of use.

The pins 14D preferably protrude in the axial direction or parallel to the axis L or downwards in the normal position of use.

The pins 14D are preferably formed at least essentially cylindrical or as (solid) cylinders or prisms. In the illustrative example, shown in FIG. 3, the pins 14D have preferably a cross section or prism base in the form of a cross.

Particularly preferably, the connection between the pins 14D and the receptacles 14E is self-centering and/or (the tips of) the pins 14D are chamfered or comprise insertion chamfers.

Additionally or alternatively, the housing parts 14A, 14B may be latched/interlocked or latchable/interlockable to/with each other or may be snapped together, for example along their circumference. It is also possible that the housing parts 14A, 14B are connected to each other in a bonded manner, for example glued and/or welded, in particular ultrasonically welded, to each other.

Preferably, a dividing plane E of the outer housing 14 and/or between the housing parts 14A, 14B extends transversely to the axis L and/or transversely to the supply channel 11, the conduit 12, the riser 13 and/or the axis of symmetry of the conveying device 4, of the conveyor housing 4A and/or of the bellows 5 and/or transversely to the (main) conveying direction of the fluid F in the dispenser 1, in the dispensing device 2, in the supply channel 11, in the conduit 12, in the riser 13, in the conveying device 4 and/or in the bellows 5, and/or transversely to the vertical in the position of use. The dividing plane E is drawn in FIG. 1.

The main conveying direction of the fluid F is preferably to be understood as the direction in which the fluid F is mainly conveyed or conveyable in the dispenser 1 and/or the dispensing device 2, and/or as the pumping direction, in particular in the bellows 5. The main conveying direction runs in particular in the axial direction.

The angle between the dividing plane E and the axis L is preferably at least 60°, in particular at least 700 or 80°, and/or at most 90°. In particular, the axis L may intersect the dividing plane E perpendicularly or at right angles. In the illustrative example, the angle between the dividing plane E and the axis L is preferably more than 800 and/or less than 90°, as in particular shown in FIG. 1A.

Preferably, the dividing plane E intersects the outer housing 14 asymmetrically or does not form a plane of symmetry or mirror plane of the outer housing 14. A mirror plane or plane of symmetry of the outer housing 14 (not shown) preferably extends along the axis L or, in the usual position of use, at least substantially vertically. In the illustrative example, the sectional plane of FIGS. 1B and 2A to 2C is the (only) symmetry plane.

Preferably, the housing parts 14A, 14B are formed differently from each other or are not mirror images of each other.

Particularly preferably, the upper housing part 14A forms a cover or cap of the dispenser 1, of the dispensing device 2 and/or of the housing 14, in particular of or for the lower housing part 14B.

The inner space formed by the housing 14, in which in particular the conveying device 4 is arranged or accommodated, is preferably delimited by the housing part 14A, in particular to the top and/or axially, and/or by the lower housing part 14B, in particular laterally and/or radially.

Preferably, the dispensing device 2 and/or conveying device 4 comprises an outlet channel 15 extending in particular transversely or perpendicularly to the axis L, or the dispensing device 2 and/or conveying device 4 forms the outlet channel 15 and/or a channel wall 15A. Preferably, the outlet channel 15 and/or the channel wall 15A is arranged in the outer housing 14, in particular in the upper housing part 14A, in particular completely.

Preferably, the fastening part 14C has a cutout or clearance or aperture 14F through which the outlet channel 15 and/or channel wall 15A extends.

Preferably, the outlet channel 15 is fluidically connected or connectable to the outlet 5B and opens into a channel opening 16. Preferably, the fluid F can exit the outer housing 14 and/or be dispensed from the dispenser 1 or dispensing device 2 via the outlet channel 15 and the channel opening 16.

The outlet channel 15 and/or the channel wall 15A and/or the opening direction of the channel opening 16 and/or the dispensing direction preferably extends in radial direction and/or at an angle to the conveying device 4, to the conveyor housing 4A, to the axis L and/or to the main conveying direction. In particular, the fluid F is first conveyed in the axial direction or along the axis L, in particular through the riser 13, the conduit 12, the supply channel 11, the conveying device 4 and/or the bellows 5, and then transversely or perpendicularly to the axis L and/or in the radial direction, in particular through the outlet channel 15. In the usual position of use, the outlet channel 15 and/or the channel wall 15A and/or the opening direction of the channel opening 16 and/or the dispensing direction extends preferably at least substantially horizontal.

Preferably, the outlet channel 15 and/or the channel wall 15A extends eccentrically or off-center from the conveying device 4 and/or the conveyor housing 4A and/or the top wall 4G and/or eccentrically or off-center in the dispensing device 2 and/or the housing 14. Preferably, the channel opening 16 is arranged eccentrically or off-center on the dispensing device 2 and/or the housing 14. In particular, the outlet channel 15 and/or the channel wall 15A and/or the channel opening 16 is located asymmetrically with respect to the plane of symmetry of the housing 14 and/or with respect to the sectional plane of FIGS. 1B and 2A to 2C.

Preferably, the dividing plane E is parallel or at least substantially parallel to the outlet channel 15 and/or to the conveying direction in the outlet channel 15 and/or to the opening direction of the channel opening 16 and/or to the exit or discharge or dispensing direction of the fluid F, and/or horizontal at least substantially horizontal in the usual position of use.

Preferably, the outlet channel 15 and the dividing plane E being at least substantially parallel is to be understood that the outlet channel 15 and the dividing plane E may enclose a small angle, in particular an angle less than 300 or 20°, in particular less than 100.

In the illustrative example, the outlet channel 15 and/or the channel wall 15A is preferably formed by the conveying device 4 or its conveyor housing 4A. However, other solutions are also possible here. For example, the outlet channel 15 or its channel wall 15A could also be formed by the outer housing 14, in particular its upper housing part 14A. It is also possible that the outlet channel 15 is formed by a separate component of the dispensing device 2, which separate component is preferably inserted or insertable into the outer housing 14.

The outlet channel 15 or its channel wall 15A is preferably supported or held/retained at the end and/or at the channel opening 16, particularly preferably by the outer housing 14 or the upper housing part 14A and/or lower housing part 14B.

Preferably, the dispensing device 2 comprises a holding element or retaining element 37 for holding, retaining and/or supporting the outlet channel 15 or the channel wall 15A.

Preferably, the outlet channel 15 extends through the retaining element 37 and/or the channel opening 16 is formed on the retaining element 37 and/or the retaining element 37 forms part of the channel wall 15A. Preferably, the outlet channel 15 extends off-center or eccentrically through the retaining element 37 and/or the channel opening 16 is arranged or formed off-center or eccentrically on the retaining element 37.

Preferably, the retaining element 37 has a larger diameter than (the rest of) the channel wall 15A.

Particularly preferably, the outer housing 14, in particular the upper housing part 14A and/or the lower housing part 14B, encloses, encompasses, embraces, supports and/or holds the retaining element 37 and/or the outlet channel 15 and/or its channel wall 15A at the end and/or at the channel opening 16.

Preferably, the retaining element 37 is formed or manufactured integrally with the outlet channel 15 and/or the channel wall 15A and/or the conveyor housing 4A.

The outlet channel 15 and/or channel wall 15A is preferably formed or manufactured integrally with or by the conveyor housing 4A.

Particularly preferably, the conveyor housing 4A forms a structural unit with the outlet channel 15 and/or the channel wall 15A, and preferably with the retaining element 37, as shown in particular in FIG. 3.

Preferably, the conveyor housing 4A is formed or manufactured integrally or as a single piece with the outlet channel 15 and/or the channel wall 15A, and preferably with the retaining element 37, in a (common) injection molding process. However, other solutions are also possible here.

The outlet channel 15 is preferably arranged or formed at the top of the conveyor housing 4A and/or the top wall 4G and/or the side facing or being held by the upper housing 14A in the assembled state.

Preferably, the outlet channel 15 extends transversely, in particular perpendicularly, to the symmetry axis or longitudinal axis of the preferably at least essentially cylindrical conveying device 4 or conveyor housing 4A, which axis in the assembled state particularly preferably coincides with the axis L.

In the usual position of use or storage, the outlet channel 15 extends preferably at least essentially horizontally.

The outlet channel 15 is preferably arranged off-center or eccentrical at the conveying device 4 or conveyor housing 4A. The outlet channel 15 preferably extends in a non-radial direction with respect to the symmetry or longitudinal axis of the conveying device 4/conveyor 4A and/or to the axis L.

The symmetry or longitudinal axis of the outlet channel 15, on the one hand, and of the conveying device 4 or conveyor housing 4A or the axis L, on the other hand, are preferably skew lines with respect to each other and/or do not intersect and/or are not coplanar, thus, do not lie in the same plane.

As already mentioned at the beginning, the dispensing device 2 and/or the outer housing 14 preferably comprises the dispensing element 36. The dispensing element 36 is preferably arranged at the location of fluid dispensing or in the direction of fluid dispensing behind the outlet channel 15 and/or the channel opening 16 and/or the retaining element 37. The fluid F is preferably dispensed at the dispensing element 36, and/or must first pass through the dispensing element 36 before it can be dispensed. The dispensing by means of or via the dispensing element 36 will be described in more detail later.

When using the dispenser 1 for the first time, it may be necessary to first actuate the conveying device 4 and/or the actuating lever 21 a few times in order to remove air from the conveying device 4 and/or to convey or pump fluid F from the container 3 into the dispensing device 2 and/or the conveying device 4 and/or the bellows 5 for the first time.

When the conveying device 4 and/or the actuating lever 21 is actuated, the fluid F preferably passes from the container 3 into the dispensing device 2 and/or the conveying device 4 and/or the bellows 5 via the supply channel 11 and/or the conduit 12 and/or the riser 13.

Preferably, the inlet valve 7 is designed/configured to open when the fluid F is conveyed by the conveying device 4 and/or when fluid pressure is present on the supply channel side, thereby allowing the fluid F to be conveyed from the supply channel 11 through the inlet valve 7 into the interior chamber 5C of the bellows 5.

The bellows 5 is preferably positionable or arrangeable in an unactuated position or rest position shown in FIGS. 1B, 2A and 2B and in an actuated or compressed position shown in FIG. 2C and/or is preferably deformable into these positions.

Preferably, the bellows 5 is adapted to automatically assume or return to the rest position, in particular by elastic return, when no force deforming the bellows 5 from the rest position acts on the bellows 5. Preferably, the bellows 5 is compressed axially or along the axis L in the actuated position. In particular, the compression of the bellows 5 takes place axially and/or parallel to the axis L and/or by pushing together or folding of the corrugated side wall 6.

On the outlet side, the bellows 5 is preferably held or fixed in a stationary and/or immobile manner, in particular by or at the conveyor housing 4A and/or top wall 4G and/or outer housing 14. Preferably, the outlet 5B and/or the conveyor housing 4A do not change their (axial) position relative to the outer housing 14 and/or the container 3 when the bellows 5 is compressed or deformed and/or when the dispensing device 2 and/or the dispenser 1 is actuated.

Preferably, the bellows 5 is movably held or fixed at the inlet side, in particular by or to the base 9. Preferably, the inlet 5A and/or the base 9 change their (axial) position relative to the conveyor housing 4A, the outer housing 14 and/or the container 3 upon compression or deformation of the bellows 5 and/or upon actuation of the dispensing device 2 and/or the dispenser 1.

Preferably, an axial movement of the base 9, in particular upwards and/or in the direction of the bellows 5, and/or a compression or volume reduction of the bellows 5 occurs during or by an actuation of the conveying device 4 and/or of the actuating lever 21.

The compression or volume reduction of the bellows 5 causes an increased pressure of the fluid F located in the interior chamber 5C of the bellows 5, so that the fluid F is present at an increased pressure at the outlet valve 8, by which the outlet valve 8 preferably opens.

Thus, the compression of the bellows 5 preferably causes the fluid F to enter the outlet channel 15 through the outlet valve 8 and to leave the outlet channel 15 via the channel opening 16 and/or the dispensing element 36, and thus to be dispensed by or out of the dispensing device 2.

When the actuation of the conveying device 4 is terminated and/or no compressive force acts on the bellows 5 (anymore), the bellows 5 preferably returns to the rest position, in particular by elastic return.

Preferably, the expansion of the bellows 5 from the compressed or actuated position to the rest position reduces the pressure in the interior chamber 5C of the bellows 5 and/or a negative pressure is created in the bellows 5 or its interior chamber 5C during the expansion, which preferably closes the outlet valve 8. Furthermore, the inlet valve 7 is preferably opened by the negative pressure, so that fluid F present in the supply channel 11 at the inlet valve 7 flows or can flow through the inlet valve 7 into the interior chamber 5C of the bellows 5.

Preferably, the inlet valve 7 is formed by the conduit 12 and the bellows 5. In particular, the inlet valve 7 and/or the bellows 5 comprises a valve element 7A formed integrally/as one piece with the bellows 5. Preferably, in a closed position of the inlet valve 7, the valve element 7A fluid-tightly closes an opening 11A of the supply channel 11 and/or of the conduit 12 which opening 11A is located at the end side and/or opens into the interior chamber 5C. In particular, the opening 11A is covered in a sealing manner by the valve element 7A—at least in the closed position.

The valve element 7A is preferably held by one or more, in particular flexible and/or web-like arms of the bellows 5 (not shown). The valve element 7A is preferably biased, in particular by means of the arms, against the opening 11A and/or the supply channel 11.

The outlet valve 8 is preferably formed by an in particular ring-like sealing lip 8A, which—at least in the closed state of the outlet valve 8—lies in a sealing manner, in particular prestressed, against a counter surface 8B, which is preferably ring-like and/or arranged coaxially with the axis L. In an open position of the outlet valve 8, the sealing lip 8A is lifted from the counter surface 8B, so that a gap is formed between the sealing lip 8A and the counter surface 8B, through which the fluid F can exit the interior chamber 5C of the bellows 5 and enter the outlet channel 15.

Preferably, the conveyor housing 4A, in particular the top wall 4G, comprises or forms the counter surface 8B.

Preferably, the conveyor housing 4A, in particular the top wall 4G, has a cutout or clearance or aperture 4B through which the fluid F enters the outlet channel 15 (shown only in FIG. 6). As mentioned above, in the preferred embodiment shown, the outlet channel 15 is preferably arranged off-center at the conveyor housing 4A and is therefore located behind the sectional plane in FIG. 1B and FIGS. 2A to 2C. Accordingly, the aperture 4B in the conveyor housing 4A is not visible/shown in these figures.

Preferably, the dispenser 1 and/or the dispensing device 2 is designed in such a way that, when the conveying device 4 is actuated, an automatic ventilation of the container 3 takes place and/or is effected, so that no (excessive) negative pressure is created in the dispenser 1 and/or the container 3 during and/or as a result of the conveying and/or dispensing of the fluid F from the container 3. Such a negative pressure could lead to a deformation of the container 3 and/or prevent or impede a (further) conveying of the fluid F from the container 3, which is undesirable.

The dispenser 1 and/or the dispensing device 2 is preferably designed/configured so that when the conveying device 4 is actuated, in particular when the bellows 5 and/or the base 9 is moved axially, a ventilation gap 17 is formed through which ventilation/aeration of the container 3 is made possible or takes place, as shown in particular in FIG. 2C.

Preferably, the dispensing device 2 comprises or forms a seat or guide 18 for the base 9 and/or the conduit 12.

The guide 18 is preferably ring-like and/or hollow cylindrical at least in portions. The guide 18 is in particular arranged coaxially to the axis L.

Preferably, the conduit 12 is held by the guide 18 and/or within the guide 18 and/or is arranged or arrangeable in the guide 18.

Preferably, the, in particular ring-like, ventilation gap 17 can be formed between the conduit 12 and the guide 18, in particular by the conduit 12 being lifted off or spaced apart from the guide 18 during an axial movement.

In particular, the ventilation gap 17 is formed between the guide 18 and the conduit 12 when the conveying device 4 is actuated, in particular when the bellows 5 is compressed and/or is deformed from the rest position to the compressed position and/or when the base 9 is moved axially upwards and/or towards the bellows 5 and/or upper housing part 14A.

The ventilation gap 17 is preferably formed during the axial movement of the base 9 and/or conduit 12 by the conduit 12 on the outside having or forming a (conically) tapered portion or an in particular conical taper 19, preferably in the region of the guide 18.

Due to the taper 19, the outer diameter of the conduit 12 is preferably changed, in particular reduced downwardly and/or with increasing distance from the bellows 5.

Due to the taper 19, in particular during an axial movement of the base 9 and/or conduit 12 (in the direction of the bellows 5 or upwards), the distance between the conduit 12 or taper 19 and the guide 18 is changed, in particular increased, so that the ventilation gap 17 is formed.

Preferably, the dispenser 1 and/or dispensing device 2 comprises an attachment or connection part 20.

Preferably, the connection part 20 forms part of or a portion of an (overall) outer housing of the dispenser 1 or dispensing device 2, in particular together with the outer housing 14.

Preferably, the connection part 20 comprises or forms the guide 18.

The connection part 20 is preferably configured to connect the dispensing device 2, the outer housing 14, in particular the lower housing part 14B, and/or the conveying device 4, in particular the conveyor housing 4A, to the container 3.

Preferably, the dispensing device 2 is attached/fixed to the container 3 with or by the connection part 20. The connection part 20 can, for example, be screwed onto the container 3 and/or be connected to the container 3 in a latching, catching or snap-in manner. However, other solutions are also possible here.

The connection part 20 is preferably arranged axially between the container 3 (on the one side) and the bellows 5, the conveying device 4 and/or the outer housing 14 (on the other side).

The conveying device 4 and/or its conveyor housing 4A and/or the lower housing part 14B are/is preferably arranged (axially) between the connection part 20 and the upper housing part 14A, or connect/connects them to each other.

The connection part 20 is preferably connected or connectable to the conveying device 4, in particular the conveyor housing 4A, and/or the outer housing 14, in particular the lower housing part 14B, particularly preferably in a latching, catching, clamping or snap-in manner. For this purpose, the connection part 20 preferably comprises one or more catch, snap-in, detent, clamp or latching elements 20A, 20B, as shown in particular in FIG. 3. However, other solutions are also possible here, for example a screw connection or a material connection.

The conveying device 4, in particular the conveyor housing 4A, and/or the outer housing 14, in particular the lower housing part 14B, preferably comprise connecting portions 4D, 4E, 14G, 14H for connection to the connection part 20.

In the illustrative example, the conveying device 4 and/or the conveyor housing 4A preferably has a flange-like and/or radially extending connecting portion 4D, in particular at the bottom of the conveyor housing 4A and/or protruding from the lateral wall 4F, and/or a connecting portion 4E, in particular protruding from the lateral wall 4F, formed as a latching or snap-in lug or a latching or snap-in pin.

Preferably, a form-fit or latching or clamping or catching or snap-in connection is formed between the connecting portions 4D, 4E of the conveying device 4 and the latching elements 20A, 20B of the connection part 20. In particular, the latching elements 20A engage around or over the flange-like connecting portion 4D and/or the latching element 20B and the connecting portion 4E engage with each other, so that a form fit or positive connection is formed between the conveyor housing 4A and the connection part 20 in the axial and/or radial direction.

In the illustrative example, the (latching or snap-in) connection between the conveyor housing 4A and the connection part 20 is preferably made at three circumferentially distributed locations, in particular locations offset by about 120°.

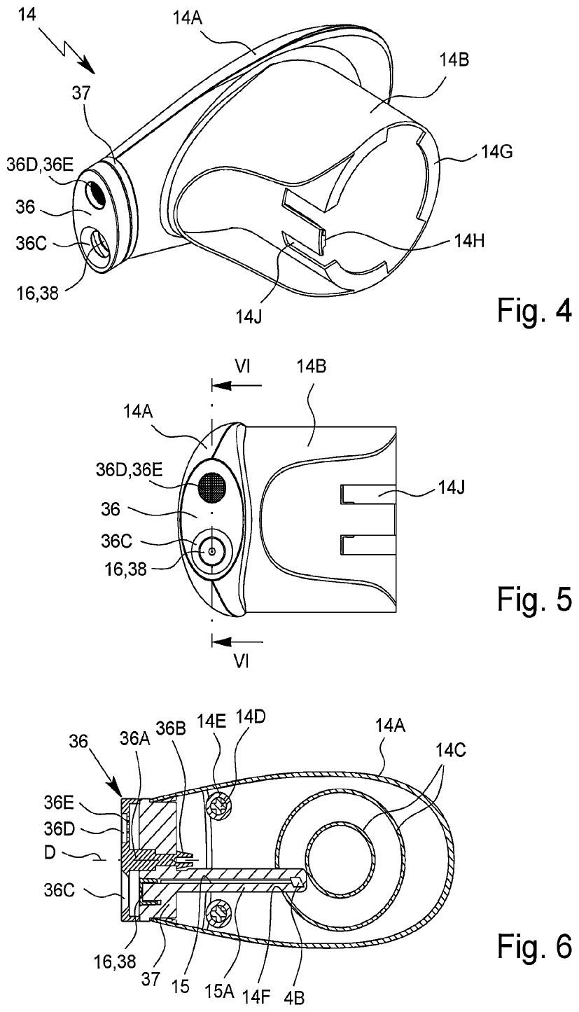

The outer housing 14 preferably has radially inwardly extending connecting portions 14G, as shown in particular in FIG. 4, which shows a perspective view of the outer housing 14. Gaps or openings/apertures are preferably formed between the connecting portions 14G, through which the latching elements 20A can preferably engage.

In the connected state, the connecting portions 14G are preferably arranged or held or clamped between the flange-like connecting portion 4D of the conveyor housing 4A and the connection part 20. In particular, the outer housing 14 and/or the lower housing part 14B is thereby fastened or fixed in the axial direction (positively/form-fittingly). The connecting portion 4D is preferably stepped and/or overlaps with the connecting portions 14G.

Preferably, in the connected state, the latching elements 20A engage around or over both the connecting portions 14G and the connecting portion 4D, thereby in particular clamping the connection part 20, the outer housing 14/lower housing part 14B and the conveying device 4/conveyor housing 4A together.

Preferably, the outer housing 14 and/or the lower housing part 14B is also fastened or fixed in radial direction (non-positively/force-fittingly) by the clamping. In addition, the outer housing 14 or housing part 14B may comprise a further connecting portion 14H which provides a radial positive fit/form fit, for example a projection which is axially inserted into a groove of the connection part 20.

More generally, the outer housing 14 or lower housing part 14B is preferably at least essentially or mainly or only (at least in the axial direction) held or fixed by clamping the outer housing 14 or lower housing part 14B, in particular one or more connecting portions 14G thereof, between the conveying device 4 or conveyor housing 4A, in particular a connecting portion 4D thereof, and the connection part 20.

Preferably, the connection part 20 is configured to be connected to the actuating lever 21. Preferably, the connection part 20 comprises a support part/mounting part/bearing part 24 for pivotally supporting the actuating lever 21 and/or for forming a pivot axis. Particularly preferably, the actuating lever 21 is latched or snapped (on)to the connection part 20 and/or bearing part 24.

Particularly preferably, all components of the dispensing device 2 can be latched, clamped, interlocked, snapped, clipped and/or clicked together, and/or the dispensing device 2 is made only by latching, clamping, interlocking, snap-in, clip and/or click connections between its individual components, in particular the outer housing 14, upper housing part 14A, lower housing part 14B, conveying device 4, conveyor housing 4A, connection part 20, actuating lever 21 and/or dispensing element 36.

However, other solutions are also possible here. In general, the outer housing 14, the upper housing part 14A, the lower housing part 14B, the conveying device 4, the conveyor housing 4A, the connection part 20, the actuating lever 21 and/or the dispensing element 36 may each be connected to one another in a force-fitting, form-fitting and/or bonded manner, in particular may be latched, snapped, clipped, clicked, screwed, glued, welded and/or injection-molded to one another. It is also possible for one or more of said parts 14, 14A, 14B, 4, 4A, 20, 21, 36 to be integrally formed and/or to form different portions of a single component.

Preferably, the dispensing device 2 and/or conveying device 4 comprises the actuating lever 21 for in particular manual actuation of the dispensing device 2 and/or conveying device 4. Preferably, actuation of the conveying device 4 and/or compression of the bellows 5 for dispensing of the fluid F is performed (exclusively) by (manual) actuation of the actuating lever 21 by a user not shown.

At this point, it should be noted that the conveying device 4 and/or dispensing device 2 can also be implemented without the actuating lever 21 and/or may be actuatable in a different manner than with the actuating lever 21 described in more detail below. Here, for example, solutions are conceivable in which the actuation of the conveying device 4 or a compression of the bellows 5 is effected by an axial movement or a pressing down of a dispensing head, as described, for example, in WO 2015/106868 A1 or US 2012/0024904 A1.

Likewise, it is also possible that the characteristics and features of the actuating lever 21 described below, in particular with respect to a securing/locking against actuation, apply independently of the realization of the conveying device 4 by or with a flexible bellows and/or as a pumping device.

The actuating lever 21 is preferably pivotably arranged or pivotably supported/mounted on the dispensing device 2 and/or the conveyor housing 4A, outer housing 14 and/or connection part 20.

The pivot axis about which the actuating lever 21 is pivotable—at least in the unlocked state—preferably extends transversely, in particular perpendicularly, to the axis L and/or, in the usual position of use, at least substantially horizontally.

The pivot axis preferably lies or extends within the outer housing 14 and/or between the axis L and the outer housing 14 and/or in the vicinity of the outer housing 14.

Preferably, the actuating lever 21 comprises an actuating portion 22 at its free end and a lever arm 23 coupled in particular to the actuating portion 22 or is formed by them.

Preferably, the actuating portion 22 extends at least substantially, in particular completely, outside the outer housing 14 and/or the conveyor housing 4A.

Preferably, the lever arm 23 is arranged at least partially or predominantly within the outer housing 14, in particular the lower housing part 14B, and/or the conveyor housing 4A, or protrudes/projects into the same.

The lever arm 23 preferably extends transversely and in particular at least substantially perpendicularly to the axis L and/or to the pivot axis.

The pivot axis preferably runs or extends through the lever arm 23.

Preferably, the outer housing 14, in particular the lower housing part 14B, and/or the conveyor housing 4A, in particular the lateral wall 4F, have/has a recess or cutout or clearance or aperture 4C, 14J through which the actuating lever 21 or lever arm 23 is passed or can be passed (shown in FIG. 3 and FIG. 4, respectively).

The actuating portion 22 is preferably designed/configured for manual actuation by a user not shown.

The actuating portion 22 may be curved or bent and/or ergonomically shaped. This is conducive to easy and comfortable operation.

The lever arm 23 is preferably configured for driving or activating the conveying device 4, in particular for actuating or compressing the bellows 5 and/or for axially moving the base 9, in particular upwards and/or towards the outlet 5B and/or the upper housing part 14A.

The lever arm 23 is preferably arranged off-center and/or at an end portion of the actuating portion 22, in particular so that an especially large leverage can be generated via the actuating portion 22 during actuation.

Preferably, the lever arm 23 and the actuating portion 22 are arranged transversely, in particular at least substantially perpendicularly, to each other.

Preferably, the dispensing device 2, particularly preferably the connection part 20, comprises the support part/mounting part/bearing part 24 on which the actuating lever 21, in particular the lever arm 23, is movably, in particular pivotably, mounted/supported or mountable/supportable.

The bearing part 24 preferably comprises one or more supporting, mounting or bearing elements 25, in particular one or more supporting, mounting or bearing pins.

Preferably, the pivot axis extends through the bearing element(s) 25, and/or is defined by the bearing part 24 and/or the bearing element(s) 25.

The actuating lever 21 preferably comprises one or more supporting, mounting or bearing portions 26 corresponding to the bearing part 24 and/or the bearing element(s) 25. The bearing portion(s) 26 are preferably recesses for engagement of the bearing element(s) 25 and/or latching elements for latching with the bearing element(s) 25.

In the following, a preferred embodiment for locking the dispensing device 2 and/or the actuating lever 21 will be described. In particular, the respective positions of the actuating lever 21 and the associated locking, securing and actuating mechanisms locking, securing and actuating devices and/or locking, securing and actuating states will be explained in more detail. However, this is by way of example only. Locking could also be implemented in other ways, in particular if no actuating lever 21 is provided, and/or a locking function could also be omitted.

The locked position of the actuating lever 21 and/or of a locking device 27 of the dispensing device 2 is shown in FIG. 2A. The dispenser 1 and/or the dispensing device 2 is accordingly in a locked state.

In the locked state and/or in the locked position, actuation and/or pivoting of the actuating lever 21 is preferably locked or blocked. In particular, an activation or actuation of the conveying device 4 and/or a dispensing of fluid F is locked or blocked/inhibited.

Preferably, the dispensing device 2 comprises a locking device 27 which locks or blocks/inhibits the actuation of the actuating lever 21 and/or the conveying device 4 in the locked state or locked position.

The locking device 27 or the locked state is preferably realized or formed by a form closure/form fit/positive locking, in particular of or between the actuating lever 21 and bearing part 24.

Preferably, the locking device 27 comprises a locking element 28.

In the locked position or locked state, the locking element 28 preferably engages positively or in a form-fitting manner in a corresponding recess 29.

Preferably, the locking device 27 is formed by and/or comprises the locking element 28 and the recess 29.

In the illustrative example, the locking element 28 is arranged or formed on the actuating lever 21, in particular on the lever arm 23, in particular integrally with the actuating lever 21 or lever arm 23.

In the illustrative example, the bearing part 24 preferably has or forms the recess 29.

Due to the locking device 27, in particular the positive locking/form fit and/or the engagement of the locking element 28 in the recess 29 in the locked state, actuation or pivoting of the actuating lever 21 is preferably locked or blocked/inhibited.

FIG. 2B shows the actuating lever 21 and/or the locking device 27 in the unlocked position or actuation position in which actuation of the actuating lever 21 and/or of the conveying device 4 is possible or enabled. In particular, the actuating lever 21 and/or the locking device 27 is unlocked and/or the positive lock/form fit/form closure formed in the locked position and/or the locked state is cancelled or released. Accordingly, the dispenser 1 and/or the dispensing device 2 is preferably in an unlocked state.

In the actuation position, the locking element 28 is preferably free and/or is not (any longer) in engagement. In particular, the locking element 28 is not (any longer) engaged with the recess 29 and/or is (completely) arranged outside the recess 29, particularly preferably in such a way that pivoting of the actuating lever 21, in particular together with the locking element 28, is possible or enabled.

For unlocking or for assuming the actuation position, the actuating lever 21 is preferably (manually) displaceable or shiftable. The actuating lever 21 and/or the locking element 28 can thus preferably be displaced or shifted or moved from the locked position into the actuation position.

The displacement/shifting of the actuating lever 21 preferably causes the locking element 28 to be pushed out of the recess 29 and/or the form closure or (positive) locking of the locking device 27 to be released.

Particularly preferably, the actuating lever 21 is linearly and/or in radial direction displaceable or pushable, in particular inwardly or in the direction of the longitudinal axis L, of the bearing part 24 and/or of the pivot bearing or pivot axis.

For moving or displacing/shifting the actuating lever 21 from the locked position to the actuation position, the actuating portion 22 is preferably movable or pushable in the direction of the longitudinal axis L, the bearing part 24, the pivot bearing or pivot axis, the conveying device 4 and/or the outer housing 14.

In the actuation position, the actuating portion 22 is also preferably arranged completely outside the outer housing 14. The distance between the outer housing 14, in particular the lower housing part 14B and the actuating portion 22, is preferably smaller in the actuation position than in the locked position.

The lever arm 23 is preferably pressable/pushable (further) into the outer housing 14 and/or the conveying device 4, in particular the conveyor housing 4A. In particular, the lever arm 23 is to a greater extent inside the outer housing 14 and/or the conveyor housing 4A in the actuation position than in the locked position. The locking element 28, which is preferably formed integrally with the lever arm 23, is preferably displaced/shifted accordingly, in particular in the direction of the longitudinal axis L.

Preferably, the dispensing device 2 and/or the actuating lever 21 and/or the locking device 27 can be locked again after unlocking and/or is lockable again and/or is displaceable from the actuation position (again) into the locked position. In particular, the (positive) locking realized by the locking device 27 or the form closure/form fit can be restored and/or the locking element 28 can be brought into engagement (again), in particular with the recess 29.

Particularly preferably, the actuating lever 21 is linearly displaceable in the opposite direction than during unlocking in order to (re)lock the dispensing device 2 and/or the actuating lever 21. Particularly preferably, the actuating lever 21, in particular the lever arm 23, is partially extractable/withdrawable/pullable from the outer housing 14 and/or the conveyor housing 4A and/or movable in radial direction away from the longitudinal axis L in order to (re)assume the locked position.

However, other solutions are also possible here, in particular in which the unlocking is irreversible. For example, the actuating lever 21 could latch/engage irreversibly in the actuation position during unlocking or the like.

The bearing part 24 and/or the bearing portion(s) 26 are/is preferably designed to hold or support/mount/bear the actuating lever 21, in particular the lever arm 23, in a displaceable manner, in particular in such a way that it can be displaced from the locked position into the actuation position, and particularly preferably also back from the actuation position into the locked position if required.

As previously mentioned, the bearing part 24 preferably comprises one or more bearing elements 25, in the illustrative example two bearing elements 25 arranged on opposite sides, in particular bearing pins. The actuating lever 21 in particular the lever arm 23, preferably has corresponding bearing portions 26 in which the bearing elements 25 engage for bearing.

Preferably, the displaceability of the actuating lever 21 is realized by the bearing portions 26. In particular, the bearing portions 26 are configured to allow the actuating lever 21 to be displaced/shifted. For example, as shown in FIG. 3, the bearing portions 26 could be formed as elongated recesses formed in the lever arm 23, in which the bearing elements 25 of the bearing part 24 are held or supported/mounted in a longitudinally displaceable manner.

Preferably, the actuating lever 21 and the bearing part 24 are connected to each other in a form-fitting manner in the locked position and/or the actuation position, particularly preferably both in the locked position and the actuation position, in particular are or can be latched, engaged, interlocked, snapped, clipped or clicked (together). In particular, the (respective) bearing elements 25 are or can be latched, engaged, interlocked, snapped, clipped or clicked in/into the corresponding (respective) bearing portions 26.

When the actuating lever 21 is displaced, in particular when it is pushed in, and/or when unlocking, the bearing element 25 is preferably displaced or moved within the bearing portion 26. However, this displacement preferably takes place only relative to the actuating lever 21. In particular, the bearing element 25 is stationary or immobile relative to the bearing part 24, connection part 20, conveyor housing 4A and/or outer housing 14. Preferably, the component actually moving is the actuating lever 21 or bearing portion 26 which causes the displacement of the bearing element 25 within the bearing portion 26.

FIG. 2C shows the actuating lever 21 in the actuated position or pivoted position. Preferably, the actuating lever 21 is pivotable between the unactuated position or actuation position shown in FIG. 2B and the actuated position or pivoted position shown in FIG. 2C, in particular about the pivot axis.

Preferably, the movement from the actuation position to the pivoted position is effected by a manual actuation or pivoting of the actuating lever 21 by a user not shown.

Preferably, the base 9, in particular the bottom element 10, forms or comprises a counter surface or actuating surface for the actuating lever 21 or lever arm 23. The actuating lever 21 or lever arm 23 preferably abuts the bottom element 10 or the actuating surface formed thereby and/or acts thereon and/or exerts a force thereon, in particular when pivoting from the actuation position to the pivoted position.

By an actuation of the actuating lever 21 and/or the actuating portion 22, in particular by a pivoting from the actuation position into the pivoted position, the bellows 5 is preferably actuated and/or compressed and/or deformed or moved from the rest position into the compressed position. This is achieved in particular by rotating the lever arm 23 about the pivot axis and/or the bearing part 24, in particular the bearing element(s) 25, during the actuation or pivoting movement, so that an end of the lever arm 23 associated with or facing the base 9 is lifted or moved towards the bellows 5.

In particular, an actuation of the actuating lever 21 and/or a pivoting of the actuating lever 21 from the actuation position to the pivoted position thus causes a compression of the bellows 5 and/or a discharge of the fluid F.

The pivot axis S, the bearing part 24, in particular the bearing elements 25, and/or the actuating lever 21, in particular the bearing portions 26, are/is preferably arranged in such a way that a small pivot angle results in a (comparatively) large stroke/lifting of the lever arm 23, and/or that the force acting on the conveying device 4—compared to a force acting on the actuating portion 22—is increased.

The pivot axis and/or the bearing elements 25 and/or bearing portions 26 are/is preferably arranged or formed within the outer housing 14 at an especially large distance from the axis L and/or close to the outer housing 14 and/or closer to the outer housing 14 than to the axis L.

Preferably, a movement of the actuating lever 21 from the actuated position or pivoted position (back) to the unactuated position or actuation position is automatic and/or does not require an active movement or actuation of the actuating lever 21. Preferably, a movement from the pivoted position to the actuation position can be effected by a user releasing or letting go of the actuating portion 22.

The expansion of the bellows 5 and/or the movement of the actuating lever 21 from the pivoted position to the actuation position, in particular caused by the expansion, is preferably effected by the (elastic) restoring force caused by the preceding elastic deformation or compression of the bellows 5. During the expansion of the bellows 5, preferably the base 9 and/or the bottom element 10 or the actuating surface formed thereby acts on or exerts a force on the actuating lever 21 and/or lever arm 23, so that the actuating lever 21 is (automatically) moved or pivoted from the pivoted position to the actuation position.

As previously mentioned, the construction/design of the dispensing device 2 and/or conveying device 4 with bellows is merely preferred. Accordingly, solutions are also possible in which pivoting the actuating lever 21 and/or raising the lever arm 23 causes in a different way activation of the conveying device 4 and/or conveying and/or dispensing of the fluid F.

Preferably, the dispensing device 2 comprises a protection device or safety device or securing device 30 in addition to the locking device 27.

The securing device 30 is preferably designed to block an unlocking of the dispensing device 2, of the actuating lever 21 and/or of the locking device 27 and/or to secure or protect the dispensing device 2, the actuating lever 21 and/or the locking device 27 against an (accidental or undesired) unlocking, in particular to block a displacing/shifting of the actuating lever 21 from the locked position into the actuation position.

Preferably, in principle, the securing device 30 may also be understood as a second locking device, locking the first locking device 27 or its unlocking mechanism. However, in order to properly distinguish the two devices and their functioning in this description, terms including “lock” such as “locked”, “unlocking”, etc. preferably refer exclusively to (un)locking by means of the locking device 27, while for the securing device 30 terms like “secured” etc. are used, unless explicitly mentioned otherwise.

The position of the securing device 30 in which the unlocking is secured or blocked is hereinafter referred to as the securing position. This position is shown in particular in FIG. 2A.

In its delivery state or before first use, the dispenser 1 and/or the dispensing device 2 is preferably locked by means of the locking device 27 and secured by means of the securing device 30.

The securing device 30 preferably comprises or is formed by a securing element 31. The securing element 31 is preferably designed to block an unlocking of the dispensing device 2, of the actuating lever 21 and/or of the locking device 27 in the securing position, preferably by form fit. In particular, the securing element 31 and/or the securing device 30 prevents the form closure or (positive) lock formed by the locking device 27 from being removed/cancelled and/or the locking element 28 from being removed or pushed out of the recess 29.

The securing element 31 is preferably elongated and/or rod-like.

Preferably, the securing device 30 and/or the securing element 31 acts in the securing position between the actuating portion 22 and the outer housing 14, in particular the lower housing part 14B and/or the connection part 20.

In particular, the securing element 31 is arranged or fixed in the securing position between the actuating portion 22 and another part of the dispensing device 2, in particular the outer housing 14 or lower housing part 14B and/or the connection part 20, so that the actuating lever 21 cannot be moved out of the locked position and/or is secured against unlocking.

Preferably, the securing device 30 and/or the securing element 31 extends in the securing position transversely, in particular perpendicularly, to the actuating portion 22 and/or at least substantially parallel to the lever arm 23 and/or in radial direction.

Preferably, the securing device 30 and/or the securing element 31 is integrally formed with or molded to the actuating portion 22 and/or the lever arm 23.

Particularly preferably, the securing device 30 and/or the securing element 31 is connected to the actuating lever 21, the actuating portion 22 and/or the lever arm 23 by a material bond and/or forms part of the actuating lever 21.

Particularly preferably, the securing device 30 and/or the securing element 31 is rigidly and/or immovably arranged or held on the actuating lever 21.

To release the securing/protection by means of the securing device 30 or to unsecure/unprotect the dispensing device 2, the actuating lever 21 and/or the locking device 27, the securing device 30 and/or the securing element 31 is preferably movable from the securing position into an unsecured or released position.

The securing element 31 is preferably releasable and/or movable into the unsecured or released position by applying a force transverse to the main extension direction of the securing element 31.

In the unsecured or released position, the securing element 31 is preferably arranged in such a way that the actuating lever 21 can be displaced/shifted and/or that the dispensing device 2, the actuating lever 21 and/or the locking device 27 can be unlocked, in particular without restriction or obstruction of the unlocking by the securing element 31. In the unsecured or released position, the locking device 27 and/or the displacement/shifting of the actuating lever 21 is preferably released/enabled.

Preferably, the securing device 30 and/or the securing element 31 can be pushed/pressed in, hinged away, folded away and/or folded up, in particular transversely to its longitudinal extension and/or in axial direction.

Alternatively, the securing device 30 and/or the securing element 31 may also be (completely) removable or breakable from the dispensing device 2, in particular the actuating lever 21.

When the securing device 30 and/or the securing element 31 has been moved out of the securing position, in particular has been folded away, folded up, hinged away, pressed in or removed, the dispensing device 2, the actuating lever 21 and/or the locking device 27 is preferably released, unblocked, unsecured, unprotected and/or not (anymore) blocked. A movement or displacement of the actuating lever 21 from the locked position into the actuation position is then possible or enabled.

Preferably, the securing device 30 and/or the securing element 31 serves as a tamper-evident seal. This is achieved in particular by the fact that re-securing is not possible. A user can therefore tell whether the dispenser 1 and/or the dispensing device 2 is still in the delivery state or has already been used by looking at the position of the securing device 30 and/or the securing element 31, in particular whether it is in the securing position, and/or looking at the state of the securing device 30 and/or the securing element 31, in particular whether it has already been actuated or removed.

Preferably, the actuating lever 21, in particular together with the locking element 28 and/or the securing element 31, is made in one piece and/or in a common manufacturing process, in particular by injection molding.

A preferred method of assembling the dispensing device 2 is described below.

First, the actuating lever 21 is placed in the actuation position on the connection part 20 or bearing part 24, in particular in the unlocked position.

Then, the actuating lever 21 is preferably displaced/shifted or moved to the locked position, in particular so that the locking element 28 comes into engagement, in particular with the recess 29. In this position, a gap is preferably formed between the securing element 31 and the connection part 20 or the bearing part 24. The outer housing 14, in particular the lower housing part 14B, is preferably placed on the connection part 20 from above, in particular connected thereto in a latching or snap-fitting manner, the gap preferably being filled by the outer housing 14 or the lower housing part 14B, so that the securing element 31 abuts against the outer housing 14 or lower housing part 14B. The actuating lever 21 is thus locked and secured.

Preferably, the conveying device 4 is then inserted from above into the lower housing part 14B, in particular latched or interlocked with the latching elements 20A, 20B of the connection part 20. Particularly preferably, the connecting portions 14G of the lower housing part 14B are thereby fixed or clamped between the conveyor housing 4A or its connecting portion 4D.

The retaining element 37 is preferably supported by or rests on the lower housing part 14B.

Then, preferably, the upper housing part 14A is connected to the lower housing part 14B, in particular by plugging and/or latching them together, and the dispensing element 36 is fixed to the retaining element 37.

Individual steps may also be carried out in a different order, for example the upper housing part 14A, the lower housing part 14B, the conveying device 4 and/or the dispensing element 36 could be connected to each other first and then placed on or connected to the connection part 20.

In the following, the dispensing element 36 and the dispensing of the fluid F will be described in more detail with reference to FIGS. 4 to 6. FIG. 4 shows a perspective view of the outer housing 14 with dispensing element 36 and retaining element 37 arranged thereon. The cylindrical (part of the) conveyor housing 4A is not shown for reasons of simplification. However, the retaining element 37 is preferably integrally formed with or formed by the conveyor housing 4A, as explained above. FIG. 5 shows a front view of the outer housing 14 or dispensing element 36. FIG. 6 shows a section through the outer housing 14 along the section line drawn in FIG. 5.

Preferably, the dispensing device 2 comprises a nozzle 38.

The nozzle 38 is preferably arranged at or in the outlet end of the outlet channel 15 and/or at the channel opening 16, and/or forms the channel opening 16.

The nozzle 38 is preferably arranged or formed in or on the outer housing 14 or retaining element 37, particularly preferably clamped into or interlocked with the retaining element 37 and/or the outlet channel 15 and/or the channel opening 16. However, other solutions are also possible here. For example, the nozzle 38 could also be formed or arranged by or in the dispensing element 36.

The nozzle 38 is preferably configured to atomize the fluid F and/or to dispense the fluid F as a spray or aerosol.

Preferably, the nozzle 38 is configured as a swirl nozzle or vortex nozzle. In particular, the nozzle 38 comprises a swirl chamber and one, preferably more, swirl channels which open in particular tangentially into the swirl chamber (not shown). Preferably, the fluid F is directed from the outlet channel 15 into the swirl chamber via the swirl channel(s). Preferably, the swirl channel(s) has/have a smaller diameter than the outlet channel 15, so that an increase in velocity of the fluid F occurs. In the swirl chamber, the fluid F is preferably swirled or receives a swirl. The fluid F can exit from the swirl chamber or nozzle 38 via an exit opening of the swirl chamber or nozzle 38, in particular with a swirl, particularly preferably as a spray or aerosol.

The dispensing element 36 is preferably be arrangeable on or connectable to the outer housing 14 and/or the retaining element 37, in particular by being plugged onto or plugged into the outer housing 14 and/or the retaining element 37. Preferably, the dispensing element 36 is held on the outer housing 14 and/or the retaining element 37 in a form-fitting or latching manner, in particular in a movable and/or rotatable manner.

Preferably, the dispensing element 36 comprises an elongated, in particular cylindrical, connecting portion 36A which projects in particular perpendicularly from the main extension plane or end face of the dispensing element 36. At its free end, the connecting portion 36A preferably comprises a head or latching, snap-in or engaging portion 36B.

The retaining element 37 preferably has a corresponding recess into which the connecting portion 36A with the latching portion 36B is or can be inserted/plugged.

Preferably, the connecting portion 36A engages through the retaining element 37 and/or the latching portion 36B engages behind the retaining element 37.

The dispensing element 36 is preferably rotatable about an axis of rotation D. The axis of rotation D preferably extends transversely, in particular perpendicularly, to the axis L and/or at least substantially parallel to the dispensing direction or opening direction of the channel opening 16 or nozzle 38.

The axis of rotation D preferably extends through or along the connecting portion 36A and/or transversely, in particular perpendicularly, to the main extension plane or end face of the dispensing element 36.

The axis of rotation D preferably extends centrally through the dispensing element 36 and/or the retaining element 37.

Preferably, the axis of rotation D forms a central axis and/or axis of symmetry of the dispensing element 36 and/or the retaining element 37.

Preferably, the dispensing element 36 and the retaining element 37 have the same shape and/or the retaining element 37 is at least substantially completely coverable or covered by the dispensing element 36.

In the illustrative example, the dispensing element 36 and/or the retaining element 37 are/is preferably elongated, in particular at least substantially oval or elliptical in shape. However, other solutions are also possible here, for example a square or circular shape.

Preferably, in a dispensing position, the longer side or major axis of the retaining element 37 and/or dispensing element 36 extends transversely or perpendicularly to the axis L and/or at least substantially horizontally in usual position of use and/or the shorter side or minor axis extends at least substantially parallel to the axis L and/or at least substantially vertically in usual position of use.

The dispensing element 36 preferably comprises a passage opening 36C, 36D through which the fluid F must pass before dispensing. In particular, the passage opening 36C, 36D is arranged or arrangeable (in the dispensing direction) behind or downstream of the channel opening 16 and/or nozzle 38.

The dispensing element 36 is preferably sealed or has a seal with respect to the retaining element 37 and/or the outer housing 14, in particular circumferentially and/or at the connecting portion 36A. In particular, the fluid F can only be dispensed via the passage opening 36C, 36D.

Preferably, the dispensing element 36 is held with preload on the retaining element 37 and/or outer housing 14 or is clamped against the retaining element 37 and/or outer housing 14, in particular in a fluid-tight manner.

The dispensing element 36 and/or the passage opening 36C, 36D is preferably configured to achieve or cause a desired dispensing form or dispensing type of the fluid F when the fluid F passes therethrough, for example as a spray or aerosol and/or foam.

Particularly preferably, the dispensing element 36 comprises a plurality of passage openings 36C, 36D, preferably (exactly) two passage openings 36C, 36D in the illustrative example.

The dispensing element 36 is preferably rotatable to selectively arrange different passage openings 36C, 36D behind the channel opening 16 and/or to selectively achieve, cause and/or set different dispensing forms of the fluid F, in particular to selectively dispense the fluid F either as a spray/aerosol or as a foam.

Preferably, the passage openings 36C, 36D are each sealed with respect to each other so that the fluid F is or can be dispensed only through the desired passage opening 36C, 36D.

In the illustrative example, the two passage openings 36C, 36D are preferably arranged side by side along the longitudinal extension or the main axis of the elongated and/or elliptical/oval dispensing element 36 and/or horizontally side by side in the usual position of use and/or symmetrically with respect to a center point and/or the axis of rotation D of the dispensing element 36.

One of the passage openings 36C, 36D, in the illustrative example the passage opening 36C, is preferably formed as a particularly conical opening or aperture in the dispensing element 36 and/or for dispensing the fluid F as a spray or aerosol.

The fluid F, preferably already atomized by the nozzle 38, can preferably pass through the passage opening 36C at least substantially unobstructed and/or be dispensed as a spray or aerosol.

Solutions are also possible in which no nozzle 38 is provided and/or in which the fluid F is dispensed or dispensable without atomization and/or as a jet.

Furthermore, solutions are also possible in which the nozzle 38 is arranged in the passage opening 36C or in which the passage opening 36C is designed as a nozzle 38. It is also conceivable that the dispensing element 36 comprises a passage opening 36C, in particular formed as an aperture, and comprises a further passage opening formed as a nozzle, in order to dispense the fluid F optionally as a jet or as a spray/aerosol.

Preferably, one of the passage openings 36C, 36D, in the illustrative example the passage opening 36D, is formed as a grid 36E or comprises a grid 36E and/or is formed for dispensing the fluid F as a foam.

Particularly preferably, the dispensing form or dispensing type of the fluid F is changed as it passes through the grid 36E, in particular to a foam.

Preferably, the grid 36E is made of plastic, in particular polyethylene, and/or is injection molded. Particularly preferably, the grid 36E is formed as described in EP 2 767 348 A1 and/or manufactured according to the method described in EP 2 767 348 A1. In this regard, the disclosure of EP 2 767 348 A1 is incorporated herein.

The grid 36E comprises a plurality of grid openings, preferably at least 25 grid openings, particularly preferably at least 50 or at least 100 grid openings.

The grid 36E comprises preferably at least 5 openings per square millimeter, in particular at least 10 openings per square millimeter.

Preferably, the grid openings taper from a first side of the grid 36E to a second side of the grid 36E, in particular with an angle between 7.5° and 450 with respect to the first and/or second side of the grid 36E, particularly preferably an angle between 150 and 22.50.

The minimal or free or clear cross-sectional surface area of each of the grid openings is preferably between 25 μm² and 10000 μm², in particular between 500 μm² and 2000 μm². In the case of quadratic grid openings, the edge length of each grid opening is preferably between 5 μm and 100 μm, in particular between 20 μm and 45 μm.

The thickness of the grid 36E is preferably between 0.1 mm and 1.5 mm, in particular between 0.2 mm and 0.8 mm.

Particularly preferably, the dispensing element 36 is formed or manufactured integrally/as one piece with the grid 36E and/or from the same (plastic) material as the grid 36E. Preferably, the dispensing element 36 is manufactured with the grid 36E in a (common) manufacturing process, in particular by injection molding. However, solutions are also possible in which the grid 36E is manufactured separately and is subsequently connected to the dispensing element 36 in a force-fit, form-fit and/or bonded manner.

Preferably, the dispensing element 36, in particular including the grid 36E, is made of a plastic material belonging to the polyethylene family.

Preferably, by rotating the dispensing element 36, in particular by at least substantially 180°, the passage opening/aperture 36C or the passage opening 36D/grid 36E can selectively be arranged behind the channel opening 16 and/or nozzle 38 and/or the desired dispensing form can be set.

The passage openings 36C, 36D may also be formed differently as described above or additional passage openings may be provided. For example, a passage opening could be formed for connection to a spray probe or a rod-, tube- or hose-shaped element, for example such passage opening could have an internal thread or other connecting means. It is also conceivable that a passage opening is formed as a sponge, so that when the dispensing device 2 or conveying device 4 is actuated, the sponge is impregnated with the fluid F and the fluid F is subsequently dispensed by application of the sponge to a surface to be cleaned or the like.

The dispensing element 36 preferably forms a closure element and/or is preferably configured to close or cover the channel opening 16 and/or nozzle 38 (fluid-tight) in a closing position. In particular, the dispensing element 36 can be rotated into the closing position.

In the illustrative example, the dispensing element 36 preferably has three different (rotational) positions. In a first dispensing position, the fluid F is dispensable as a spray or aerosol. In a second dispensing position, the fluid F is dispensable as a foam. In a closing position, the dispensing device 2 is closed and/or no fluid dispensing is possible.

In FIGS. 4 to 6, the dispensing element 36 is shown in the first dispensing position. Preferably, a position rotated at least substantially 900 with respect thereto is the closing position. A position rotated by a further 90°, or rotated from the first dispensing position by at least substantially 180°, is preferably the second dispensing position, in which preferably the grid 36E is located in front of the channel opening 16 and/or nozzle 38.

Solutions are also possible in which the dispensing element 36 has more than two dispensing positions or in which more than two dispensing forms can be set. For example, the dispensing element 36 could have a plurality of passage openings with different openings, apertures, grids, nozzles, sponges and/or connecting means for spray probes or the like.

Solutions without a closing position are also possible, where it is only possible to choose between different dispensing positions or dispensing forms.

Furthermore, solutions are also possible in which the dispensing element 36 comprises only one passage opening. Preferably, the dispensing element 36 can then be rotated into (only) one dispensing position and a closing position. For example, in the illustrative example, one of the passage openings 36C, 36D could be replaced by a continuous surface.

In general, the dispensing element 36 is preferably adapted to selectively or as required close the channel opening 16 (fluid-tight) and/or to generate different dispensing forms of the fluid F. In particular, the dispensing element 36 is rotatable to selectively arrange different passage openings 36C, 36D (downstream) behind the channel opening 16 and/or to close or cover the channel opening 16 (fluid-tight).

In general, the proposed dispenser 1 and/or the proposed dispensing device 2 can also be implemented without a pumping device or pump. For example, the dispenser 1 or container 3 may be pressurized, in particular by means of a propellant gas. In this case, the conveying device 4 is preferably designed as a valve or comprises a valve. When the conveying device 4 is actuated and/or the valve is open, the fluid F is preferably automatically dispensed from the dispenser 1 or the dispensing device 2 by the increased pressure. By actuating the actuating lever 21, the conveying device 4 can preferably be controlled or activated, in particular the valve can be opened. As already mentioned, the dispenser 1 and/or the dispensing device 2 can also be designed without an actuating lever 21, or actuation can take place in a different manner.

Particularly preferably, the dispenser 1 and/or the dispensing device 2 are recyclable or made (exclusively) of recyclable material or recyclable plastic. In particular, the container 3, the conveying device 4, the conveyor housing 4A, the bellows 5, the base 9, the riser 13, the outer housing 14, the outlet channel 15, the connection part 20, the actuating lever 21, the bearing part 24, the locking device 27, the locking element 28, the securing device 30, the securing element 31, the closure element/dispensing element 36 and/or other components of the dispensing device 2 and/or of the dispenser 1, particularly preferably all components of the dispensing device 2 and/or of the dispenser 1, are made of or formed from recyclable material or recyclable plastic and/or plastic from the polyethylene family.

Individual aspects and features of the present invention, in particular of the different embodiments, may be realized and advantageous individually and in any combination.

Reference List:

| | |
|---|---|
| 1 | Dispenser |
| 2 | Dispensing device |
| 3 | Container |
| 4 | Conveying device |
| 4A | Conveyor housing |
| 4B | Aperture |
| 4C | Clearance |
| 4D | Connecting portion |
| 4E | Connecting portion |
| 4F | Lateral wall |
| 4G | Top wall |
| 5 | Bellows |
| 5A | Inlet |
| 5B | Outlet |
| 5C | Interior chamber |
| 6 | Side wall |
| 7 | Inlet valve |
| 7A | Valve element |
| 8 | Outlet valve |
| 8A | Sealing lip |
| 8B | Counter surface |
| 9 | Base |
| 10 | Bottom element |
| 11 | Supply channel |
| 11A | Opening |
| 12 | Conduit |
| 13 | Riser |
| 14 | Outer housing |
| 14A | Upper housing part |
| 14B | Lower housing part |
| 14C | Fastening part |
| 14D | Pin |
| 14E | Receptacle |
| 14F | Aperture |
| 14G | Connecting portion |
| 14H | Connecting portion |
| 14J | Clearance |
| 15 | Outlet channel |
| 15A | Channel wall |
| 16 | Channel opening |
| 17 | Ventilation gap |
| 18 | Guide |
| 19 | Taper |
| 20 | Connection part |
| 20A | Latching element |
| 20B | Latching element |
| 21 | Actuating lever |
| 22 | Actuating portion |
| 23 | Lever arm |
| 24 | Bearing part |
| 25 | Bearing element |
| 26 | Bearing portion |
| 27 | Locking device |
| 28 | Locking element |
| 29 | Recess |
| 30 | Securing device |
| 31 | Securing element |
| 36 | Dispensing element |
| 36A | Connecting portion |
| 36B | Latching portion |
| 36C | Passage opening |
| 36D | Passage opening |
| 36E | Grid |
| 37 | Retaining element |
| 38 | Nozzle |
| D | Axis of rotation |
| E | Dividing plane |
| F | Fluid |
| L | Axis |

1-30. (canceled)

31. A dispensing device for dispensing a fluid, wherein the dispensing device comprises an outer housing, a conveying device received in the outer housing, and an outlet channel having a channel opening,
wherein the conveying device has a conveyor housing,
wherein the conveyor housing is accommodated completely in the outer housing, and/or
wherein the conveyor housing forms a structural unit together with the outlet channel and/or is formed integrally with the outlet channel, and/or
wherein the conveyor housing holds the outer housing axially and/or fixes the outer housing to a connection part for connecting the dispensing device to a container, and/or
wherein the conveying device, the outer housing and a connection part for connecting the dispensing device to a container are connected to one another exclusively by plugging together and/or interlocking.

32. The dispensing device according to claim 31, wherein a flexible bellows is arranged completely within or held by the conveyor housing.

33. The dispensing device according to claim 32, wherein the flexible bellows is held at its upper end by the conveyor housing.

34. The dispensing device according to claim 31, wherein the conveyor housing is at least essentially hollow cylindrical and/or closed at the top.

35. The dispensing device according to claim 34, wherein the conveyor housing comprises an aperture at the top which opens into the outlet channel.

36. The dispensing device according to claim 31, wherein the outer housing and/or the conveyor housing comprises a clearance through which an actuating lever is passed.

37. The dispensing device according to claim 31, wherein the outlet channel is arranged off-center on the conveyor housing and/or off-center in the outer housing.

38. The dispensing device according to claim 31, wherein the outer housing is formed in multiple parts, wherein a dividing plane of the outer housing runs transversely with respect to a central axis or longitudinal axis of the conveying device and/or at least essentially parallel to a longitudinal extension of the outlet channel.

39. The dispensing device according to claim 31, wherein a rotatably mounted dispensing element is arranged at the channel opening, wherein different dispensing forms of the fluid are selectable by rotating the dispensing element having a plurality of passage openings and/or wherein the dispensing element has a passage opening with a grid for changing the dispensing form of the fluid.

40. The dispensing device for dispensing a fluid, wherein the dispensing device comprises an outer housing, a conveying device received in the outer housing, and an outlet channel having a channel opening,
wherein a rotatably mounted dispensing element is arranged at the channel opening, wherein different dispensing forms of the fluid can be set by rotating the dispensing element with a plurality of passage openings and/or wherein the dispensing element has a passage opening with a grid for dispense forming of the fluid, and/or
wherein the outer housing is formed in multiple parts, wherein a dividing plane of the outer housing runs transversely with respect to a central axis or longitudinal axis of the conveying device and/or at least essentially parallel to a longitudinal extension of the outlet channel.

41. The dispensing device according to claim 40, with at least one of
the fluid is dispensable selectively as a spray or as a foam by rotating the dispensing element,
the channel opening is closable by means of the dispensing element,
the dispensing element, including the grid, is made in one piece and/or by injection molding, or
the dispensing element is elliptical or oval shaped.

42. The dispensing device according to claim 31, wherein the connection part comprises a latching element which engages over both a connecting portion of the conveying device and a connecting portion of the outer housing thereby clamping the connection part, conveying device and outer housing together.

43. The dispensing device according to claim 31, wherein the outer housing comprises two housing parts which are or can be plugged together or interlocked.

44. The dispensing device according to claim 31, wherein the outer housing holds and/or supports the conveying device and/or the outlet channel.

45. The dispensing device according to claim 31, wherein the channel opening and/or passage opening is arranged off-center on the dispensing device and/or on the outer housing.

46. The dispensing device according to claim 31, wherein the dispensing device or conveying device comprises an actuating lever for actuating the conveying device.

47. The dispensing device according to claim 31, wherein all components of the dispensing device are made of recyclable plastic and/or plastic from the polyethylene family.

48. A method for manufacturing a dispensing device for dispensing a fluid from an associated container, comprising:
interlocking a conveyor housing of the conveying device with a connection part associated with the container and, thereby, fixing a connecting portion of the outer housing between the conveyor housing and the connection part, and/or
connecting a conveying device, an outer housing and a connection part of the dispensing device to one another exclusively by plugging together and/or interlocking.

49. The method according to claim 48, wherein the conveying device is arranged in a lower housing part of the outer housing and the outer housing is closed with an upper housing part.

50. The method according to 48, wherein the upper housing part is plugged onto and/or interlocked with the lower housing part.
